(19) United States
(12) Patent Application Publication
(10) Pub. No.: US 2018/0134438 A1
(43) Pub. Date: May 17, 2018

(54) MULTIPURPOSE JABA-TYPE AGRICULTURAL CONTAINER, AND ITS MANUFACTURING PROCESS

(71) Applicant: FRANCISCO FELIX ARAUJO, Ahome Sinaloa (MX)

(72) Inventor: FRANCISCO FELIX ARAUJO, Ahome Sinaloa (MX)

(21) Appl. No.: 15/465,566

(22) Filed: Mar. 21, 2017

(30) Foreign Application Priority Data
Nov. 16, 2016 (MX) MX/A/2016/015084

(51) Int. Cl. B65D 1/22; B65D 1/42; B65D 21/02; B65D 85/34; B65D 81/26; B29C 49/04; B29C 49/06; B29C 49/42; B29C 49/00; B29B 13/06; B29B 13/10

(52) U.S. Cl. CPC B65D 1/22; B65D 1/42; B65D 21/0209; B65D 85/345; B65D 81/263; B29K 2067/003; B29C 49/06; B29C 49/4273; B29C 49/0005; B29B 13/06; B29B 13/10; B29C 49/04

(57) ABSTRACT

The invention herein is related to the recycling industry in general, it is specifically related to a plastic container, preferably made of PET (polyethylene terephthalate), which can be molded, preferably, through blown air, defined by a back face, a front face, two lateral face, a lower face and an upper face, the multipurpose jaba-type agricultural container, and its manufacturing process, is cut manually or with a machine, and the front face is removed, to define an internal cavity and form the jabs-type container defined by a back wall and four perimeter walls, it has enough resistance to hold the weight of the products it contains, it also has a perimeter tab, on the external face of the lower edge, which allows the vertical stacking of several containers, with enough strength to evenly fold the weight, when being stacked, such container also contains several vertical ribs on the perimeter walls, and a main perimeter rib used as reinforcement elements, as well as holes on the sides that allow the release of gas generated by the products inside the container.

This application claims the benefit of Mexico application number: MX/a/2016/015084 filed on Nov. 16, 2016. The content of this document and the entire disclosure of publications, patents, and patent documents mentioned herein are incorporated by reference.

### FIELD OF INVENTION

The invention herein is related to the recycling industry in general, namely, a plastic container, preferably made from PET (Polyethylene terephthalate) or another synthetic polymer, which consists of a multipurpose, jaba-type agricultural box or container, or its manufacturing process, which is resistant enough to hold the weight of several products.

### INVENTION BACKGROUND

Currently, there are efforts made internationally for the promotion of policies and mechanisms that generate environmental improvements; one of the main actions is to contribute to solid waste handling, such as PET. Only 15% of this material is recycled annually, in our country.

The multipurpose jaba-type agricultural container, and its manufacturing process in the invention herein, is a feasible alternative for the PET plastic recycling industry, consisting of 100% recycled materials, considering the environment in its manufacturing process, using cleaning additives that are environmentally harmless.

This container has a higher structural resistance than containers currently found in the market, such as wood, Styrofoam or hard plastic. In addition, being manufactured with the injection or blown extrusion, it significantly reduces production costs, in comparison to other manually manufactured containers, such as wood containers, and containers manufactured with thermo-fusion tongue-and-groove joining molds.

Regarding the other jaba-type containers, the invention herein counts on innovative adjustments to the manufacturing process for such containers. There are no jaba-type containers in the market with manual cuts or use of machinery after blowing. It is worth mentioning that the container has a lower cut on the bottom wall, in order to firmly stack several containers vertically, to allow the escape of gases generated by the products inside the container.

In the case of blow molding, there are several bottles of different sizes, as well as drums. Nevertheless, no jaba-type containers have been found, which fulfill the same objectives.

A search was performed in order to define the closest technique status. The patent applications found are presented below:

Patent application MX/a/2009/001493 was found, dated Feb. 9, 2010 by Sean T. Ogburn, protecting a container box, which includes a lower wall with several divisions, defining several container bags, and a peripheral wall that extends upward, towards the lower wall. The lower and peripheral walls are thermoformed with a single plastic sheet, just as recycled PET bottles. The optional aspects include stabilization legs, a peripheral lip to avoid consolidation, and flexible retainers that protrude from the bags, in order to provide a tight fitting with bottles.

The patents described above is thermoformed, with a single plastic sheet, which is used for the lower wall and the peripheral wall. Nevertheless, the structural elements are separate, and there are not enough elements to allow for a higher resistance; thus, the useful life of the box is short. It is worth mentioning that it is thermoformed with a single sheet, it is not generated through blow injection molding or blow extrusion.

Patent application PA/a/2005/008602 was found, dated Aug. 12, 2005, by Charles Jonathan Britton, which protects a “container, the method, and the manufacturing equipment thereof, with a body and an edge defining an opening for the container, the container is manufactured with materials such as PET or PEN, it is manufactured in a two-stage process. The first stage comprises injection molding of a preform, with an edge formed on the opening, and a continuous portion forming the body, which extends across the preform, from the inner periphery of the edge. The edge has an extension oriented outwards, and a portion oriented downwards, spaced outward from the inner edge, and a portion extending outward, located outside the portion extending downwards. In the second stage, the preform is placed in the molding cavity of a blow molding apparatus at a high temperature, the preform is placed through the edge. The portion formed by the body is extended across the cavity, forming the lateral wall, and the bottom wall of the container. The upper region of the lateral wall touches the portion that extends downward across the edge, in order to form a box section. The lateral wall counts on tier, on the upper lateral region, over which the cavity diameter is substantially the same or close to the diameter of the portion extending downwards from the edge. Below the tier, the diameter is less than the inner periphery of the edge, and it is tapered thereof to the inside, and downwards, towards the bottom wall, at an acute angle, through which the containers can be connected.

With regard to the foregoing, the invention herein overcomes the disadvantages of the aforementioned container, as it develops better techniques for the manufacturing process, and it allows the mass production of structurally resistant containers, with significant advantages that reduce production costs.

### INVENTION OBJECTIVES

The main objective of the invention herein is to make an innovative jaba-type agricultural container available for multiple purposes, as well as its manufacturing process. The container is highly resistant, and it can be used to carry fruits, vegetables, substrates or other agricultural and household materials.

Another objective of the invention is for such multipurpose jaba-type agricultural container, and its manufacturing process, to also use 100% recycled materials, mainly from PET or other synthetic polymers.

Another objective of the invention is for such multipurpose jaba-type agricultural container, and its manufacturing process, to also provide advantages and a larger useful life, over other containers made of wood, or Styrofoam, which is highly pollutant.

Another objective of the invention is to provide a manufacturing process of a multipurpose jaba-type agricultural container through blow molding, used for mass production, which allows the reduction of production costs.

Another objective of such multipurpose jaba-type agricultural container and its manufacturing process is to count on several sizes, according to the customer's needs.

Another objective of such multipurpose jaba-type agricultural container and its manufacturing process is to count on lateral fixation means, which allow an easy handling and transportation.

Another objective of such multipurpose jaba-type agricultural container and its manufacturing process is to also have holes or slots on the lateral walls to release the gas generated by the products inside the container.

Another objective of such multipurpose jaba-type agricultural container and its manufacturing process is to be more resistant in the perimeter edge, in order to be used vertically and to stack several containers, saving space during transportation.

Another objective of such multipurpose jaba-type agricultural container and its manufacturing process is to also provide easy manufacturing for mass production.

Another objective of such multipurpose jaba-type agricultural container and its manufacturing process is to save time and work force during its production.

Another objective of such multipurpose jaba-type agricultural container and its manufacturing process is to make it affordable for several socioeconomic levels.

All these qualities and objectives will become evident when making a general and detailed description of this invention, supported on the illustrated modalities.

### BRIEF INVENTION DESCRIPTION

In general, the process for the multipurpose jaba-type agricultural container, according to the invention herein, consists of the following stages:
A) Recycled PET plastic selection and treatment: the product is obtained already clean, through the removal of impurities and other materials that may affect the quality of the final product, such as degraded or burned plastic, other types of plastic (PVC, PP, PE) and other types of plastic bottles that are not compatible (color, shape, etc.).
B) Crushing: the selected PET plastic is transferred to a crushing mill, which generates standard size flakes (<10 mm).
C) Washing, rinsing and drying: this is usually performed before crushing, even though the container can be initially washed, with a washing machine with hot water at a given temperature, between 40 and 90° C., with the corresponding environmentally friendly chemical cleaners, eliminating organic residue on the flakes surface (dirt, sand, glue residue, among others). The cleaning chemicals are eliminated through successive rinses with water. The material is also washed to remove other impurities (polyolefin, paper, among others) by density and flotation difference. Sometimes, friction, centrifugation, cyclone methods are used to improve washing and the removal of undesirable elements. The crushed products that have been washed, are now dried (between 150 and 180° C.) for their storage or subsequent extrusion.
D) Extrusion: in this process, the clean flakes are dried and subjected to extrusion, at a temperature of 230° C., and pressure, to obtain fine and dry grains (pellets), which turn into raw material to use for the generation of the preform.
E1) Preform generation: the raw material is placed in an injection machine, in order to produce a tube-shaped vial (preform) through thermofusion, around 40 cms. long, and 700 grams of weight.
E2) In a different modality, the invention is not made from a preform, and the molding through injection-blow method generates a tubular sleeve through extrusion, called parison, which is tightly closed on the bottom, due to the pressure exerted by the parts of the mold, once it is closed. It is then blown, allowed to cool, and expelled, generating a rectangular prism-shaped container.
F) Generation of a rectangular drum-type, prism-shaped container, with several weights, sizes and thicknesses, through the molding method called injection-blow; the preform is placed, previously heated, in a blowing machine, for its subsequent expansion; the jaba-type container mold is 60 long by 40 cms. wide, and 24 cms. high. Once the preform is placed on the mold, it is blown and a rectangular prism-shaped body is generated.
G) Cutting and removing the back face of the rectangular prism-shaped body to generate a jaba-type container, with a perimeter protrusion on the back face, which outlines the bottom and forms a tab for vertical stacking of several jabs-type containers.
H) Making holes: either on the perimeter walls, the lower or upper walls, to allow the release of gases generated by the products inside the container.

The generated preform has a gain body defined by an upper opening, with a main upper retention ring, followed by a second support ring, and a cylinder body, defined by the wall thickness and a lower edge, defining a sealed base with a previously determined base inner diameter. This preform is adapted to be mounted or installed on a mold, inside a blowing machine, to receive hot, pressurized blown are for its molding.

Using the blown preform, a rectangular prism-shaped body is generated, defined by a back face, a front face, two lateral faces, an upper face and a lower face. Seeing the upper face from an elevation perspective, comprised by the blown opening, seeing the body in a vertical position; such rectangular prism-shaped body, from which the back face is removed, where the back face defines the bottom and the lateral, lower and upper faces defining the perimeter edge, outlining an inner cavity to form a jaba-type container, adapted to receive substrates, materials, agricultural products, among others.

The jaba-type container seen from a conventional perspective is, formed from the rectangular prism-shaped body faces, the back face forms the bottom wall, and the lateral, upper and lower faces of the rectangular-prism shaped body form the perimeter walls of the jabs-type container. Preferably, the jaba-type container has a perimeter protrusion on the outer side of the back face defining the bottom), which comprises a tab to allow the vertical stacking of several jabs-type containers. In addition, such jaba-type container contains several holes, slots or bores with different shapes on the lower face, or the perimeter faces, which allow the release of gases inside the containers to the outside. Such perimeter walls also comprise several vertical ribs, and a main perimeter rib as container reinforcement elements.

In a different modality of the jaba-type container invention, it contains cavities or hollows on the opposite perimeter walls, for grip, in order to transfer the container from one place to another.

In a different modality of the invention, the jabs-type container back wall has a grid formed by several intertwined ribs, to provide greater structure resistance.

To better understand the invention characteristics, the following descriptions is included, as an integral part thereof, drawings are included, in an illustrative but not restrictive way, which are fully described below.

### SHORT DESCRIPTION OF FIGURES

FIG. 1 is a manufacturing process flow chart related to the multipurpose jaba-type agricultural container.

FIG. 2 is a front view of the preform, from which the multipurpose jaba-type agricultural container is formed, through molding.

FIG. 3 is a front, elevated view of the rectangular prism-shaped body, obtained through the preform molding.

FIG. 4 shows a lower perspective of the multipurpose jaba-type agricultural container, showing the details of the back wall with perimeter protrusion, and the grid formed by several intertwined ribs.

FIG. 5 shows a conventional perspective of the multipurpose jaba-type agricultural container, with the upper wall cut off.

FIG. 6 is a conventional perspective of two vertically overlapped or stacked containers.

To better understand the invention, a detailed description of some of its modalities is found below, shown through the illustrative, but not limiting drawings attached to the description herein.

### DETAILED DESCRIPTION OF THE INVENTION

The characteristic details of the multipurpose jaba-type agricultural container, and its manufacturing process, are clearly shown through the following description and the illustrative drawings attached, with the same reference signs to point out the same parts.

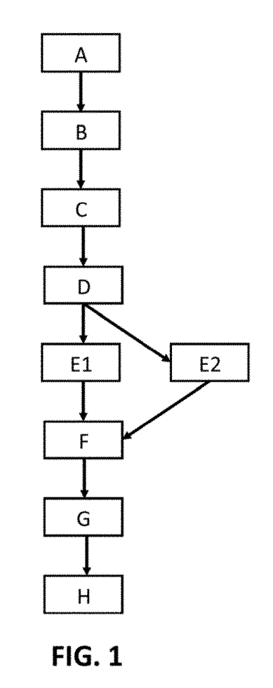

In reference to FIG. 1, showing a multipurpose jaba-type agricultural container manufacturing process flow chart, the following stages are shown:
A) Recycled PET plastic selection and treatment: the product is obtained already clean, through the removal of impurities and other materials that may affect the quality of the final product, such as degraded or burned plastic, other types of plastic (PVC, PP, PE) and other types of plastic bottles that are not compatible (color, shape, etc.).
B) Crushing: the selected PET plastic is transferred to a crushing mill, which generates standard size flakes (<10 mm).
C) Washing, rinsing and drying: this is usually performed before crushing, even though the container can be initially washed, with a washing machine with hot water at a given temperature, between 40 and 90° C., with the corresponding environmentally friendly chemical cleaners, eliminating organic residue on the flakes surface (dirt, sand, glue residue, among others). The cleaning chemicals are eliminated through successive rinses with water. The material is also washed to remove other impurities (polyolefin, paper, among others) by density and flotation difference. Sometimes, friction, centrifugation, cyclone methods are used to improve washing and the removal of undesirable elements. The crushed products that have been washed and purified, are now dried (between 150 and 180° C.) for their storage or subsequent extrusion.
D) Extrusion: in this process, the clean flakes are dried and subjected to extrusion, at a temperature of 230° C., and pressure, to obtain fine, and dry grains (pellets), which turn into raw material to use for the generation of the preform.
E1) Preform generation: the raw material is placed in an injection machine, in order to produce a tube-shaped vial (preform) through thermofusion, around 40 cms. long, and 700 grams of weight.
E2) Paris on generation: in a different modality, the invention is not made from a preform, and the molding through injection-blow method generates a tubular sleeve through extrusion, called parison, which is tightly closed on the bottom, due to the pressure exerted by the parts of the mold, once it is closed. It is then blown allowed to cool, and expelled, generating a rectangular prism-shaped container.
F) Generation of a rectangular drum-type, prism-shaped contain with several weights, sizes and thicknesses, through the molding method called injection-blow; the preform is placed, previously heated, in a blowing machine, for its subsequent expansion; the jaba-type container mold is 60 long by 40 cms. wide, and 24 cms. high. Once the preform is placed on the mold, it is blown and a rectangular prism-shaped body is generated.
G) Cutting and removing the back face of the rectangular prism-shaped body to generate a jaba-type container, with a perimeter protrusion on the back face, which outlines the bottom and forms a tab for vertical stacking of several jaba-type containers.
H) Making holes: either on the perimeter walls, the lower or upper walls, to allow the release of gases generated by the products inside the container.

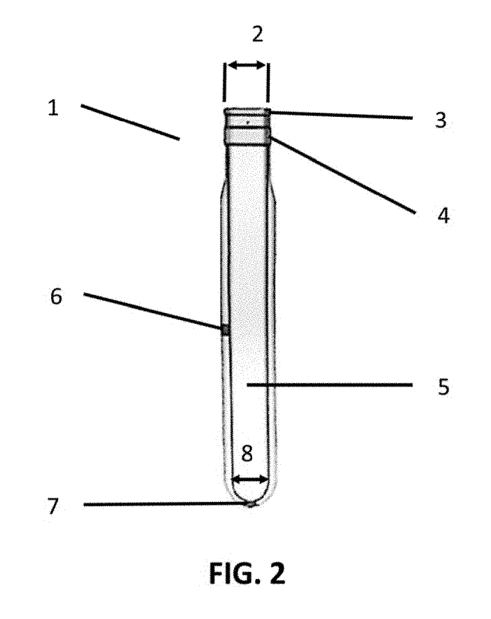

In reference to FIG. 2 showing the preform (1), which will be used for the generation of the multipurpose jaba-type agricultural container, this preform (1) has a main body configuration, defined by an upper opening (2) with a main upper retention ring (3), followed by a second support ring (4) and a cylindrical body (5) of the main body defined by a wall thickness (6) and a lower edge, defined by a sealed base (7) with a previously defined inner base diameter (8); such preform (1) will be adapted to be mounted or installed on a mold, inside a blowing machine, or it will be installed on a mold inside a blowing machine, to receive pressurized blown air for its molding.

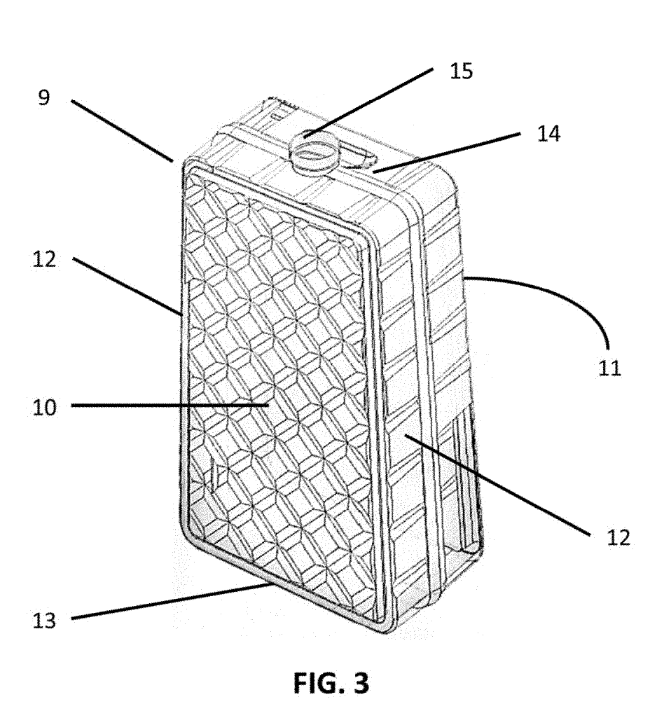

In reference to FIG. 3, showing a rectangular prism-shaped body (9) obtained through molding from the preform (1, see FIG. 2), which is defined by a back face (10), a front face (11), two lateral faces (12), a lower face (13) and an upper face (14). The upper face (14) seen from an elevation perspective, comprising the blowing opening (15).

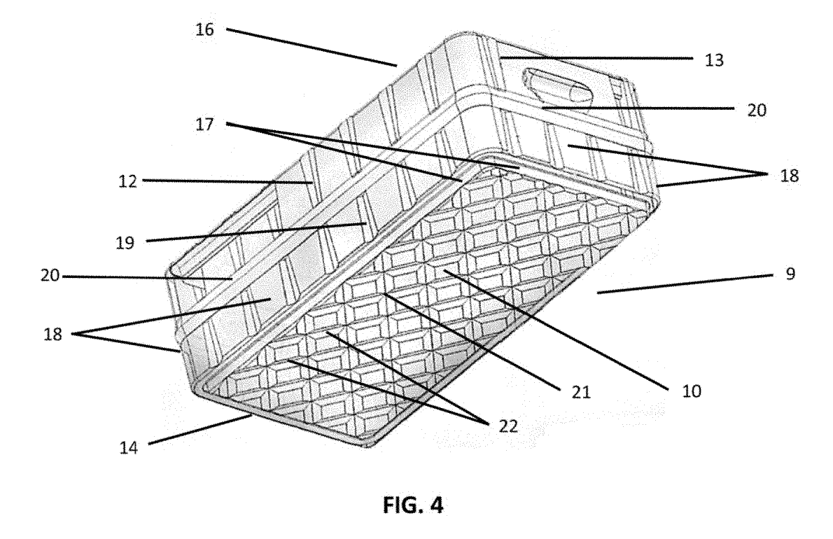

In reference to FIG. 4, showing the back face (1) of the rectangular prism-shaped body (9), which forms the bottom wall of the jaba-type container (16), on such bottom wall (back face 10) of the jaba-type container (16) a perimeter protrusion (17) is observed, which forms a tab to allow the vertical stacking of several jaba-type containers. Once the lateral faces (12), the lower face (13) and the upper face (14) of the rectangular prism-shaped body (9) will form the perimeter walls (18) of the jaba-type container (16), such perimeter walls (18) comprise several vertical ribs (19) and a main perimeter rib (20) as reinforcing elements of the jaba-type container (16). In a different modality of the invention, the jaba-type container back wall (bottom wall 10) has a grid (21) formed by several intertwined ribs (22), to provide greater structure resistance.

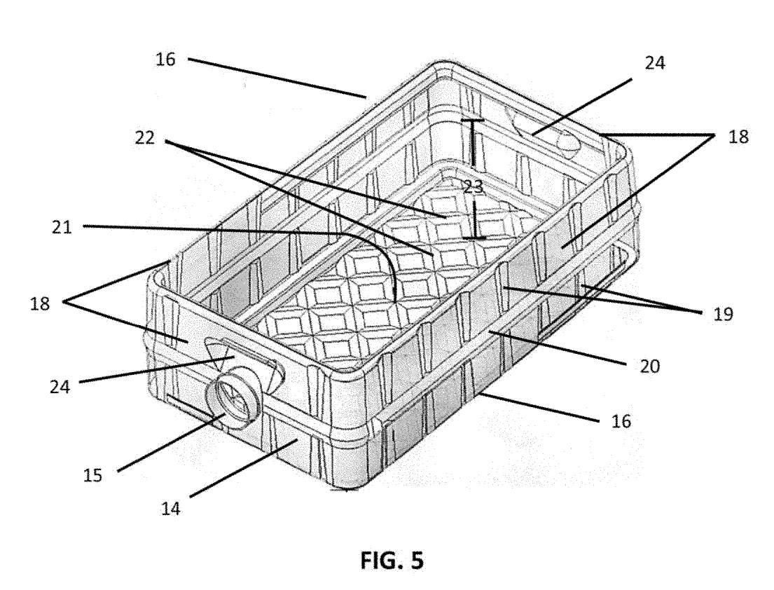

In reference to FIG. 5, showing such jaba-type container (16), whose upper face (not shown) has been cut off, the inner cavity (23) is defined to form a jaba-type container (16) adapted to receive substrate, materials, agricultural products, among others. It is observed that it contains several cavities or hollows (24) in all the opposite perimeter walls, as fixation elements to move the container from one place to another. The upper face (14) seen from an elevation perspective, comprising the blowing opening (15).

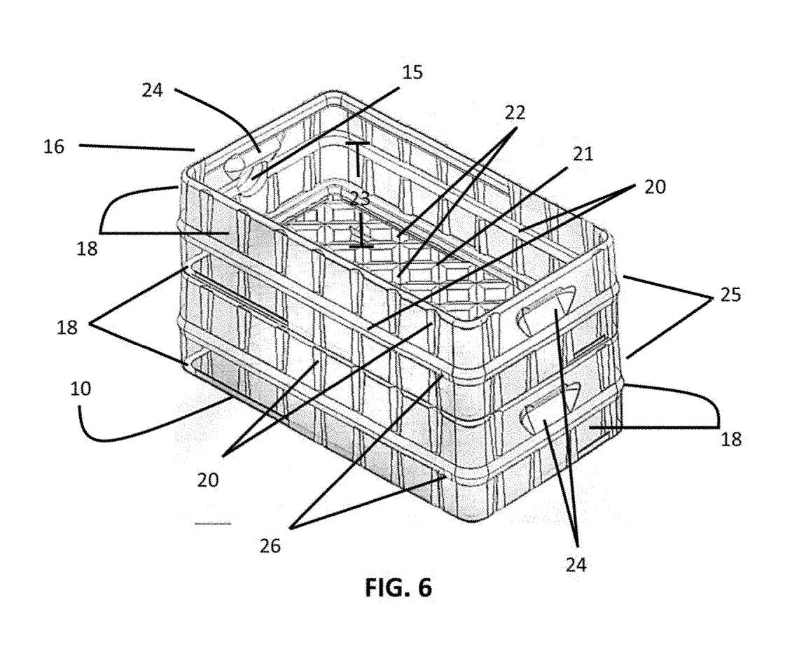

In reference to FIG. 6 showing two vertically stacked containers (25), it can be observed that this jaba-type container (16) comprises several holes (26), slots or bores in different shapes on the bottom wall (back wall 10), or its perimeter walls (18), which allow the release of gases inside the container, to the outside.

The invention has been described enough for a person with medium knowledge on the field to reproduce and obtain the results mentioned in the invention herein. Nevertheless, any person with skills in the technical field related to this invention is able to make adjustments that have not been described in the request herein. Nevertheless, if the application of these adjustments on a certain structure or the manufacturing process thereof, the matters stated in the following claims are required, such structures must be included within the scope of the invention.

1. A multipurpose jaba-type agricultural container formed by a rectangular prism-shaped container or body, in the shape of a drum, with different weights, sized and thicknesses, characterized by that rectangular prism-shaped body being obtained through blow injection or blow extrusion molding of polymer materials, which is defined by a back face, a front face, two lateral faces, a lower face and an upper face, whose front face is removed to define an internal cavity and form a jabs-type container defined by a bottom wall ((back face) and perimeter walls (lateral, upper and lower faces), comprising several vertical ribs on the perimeter walls, and a main perimeter rib used as reinforcement elements.

2. The multipurpose jaba-type agricultural container, according to claim 1, characterized by the bottom wall of such container containing a grid formed by several intertwined ribs, defining elements that provide greater structural resistance.

3. The multipurpose jaba-type agricultural container, according to claim 1, characterized by also containing several holes, slots or bores in different shapes on its back wall and/or the perimeter walls, in order to allow the release of gas inside the container to the outside and/or for venting.

4. The multipurpose jaba-type agricultural container and its manufacturing process, according to claim 1, characterized by the back wall having a protrusion, on the outer face, defining a perimeter support tab to vertically stack several containers.

5. The multipurpose jaba-type agricultural container, according to claim 1, characterized also for having several cavities or hollows on all opposite perimeter walls, as fixation methods to move the container from one place to the other.

6. A manufacturing process for a multipurpose jabs-type agricultural container according to claim 1, characterized by comprising the following stages: recycled PET selection and treatment, crushing, washing and drying, extrusion, generation of a preform or parison, molding through injection blow or extrusion blow, generation of a rectangular prism-shaped body, cutting and removing the front face of the rectangular prism-shaped body to generate a jabs-type container, and making holes on the perimeter and/or back walls.
